(19) United States
(12) Patent Application Publication
(10) Pub. No.: US 2024/0345276 A1
(43) Pub. Date: Oct. 17, 2024

(54) ELECTROMAGNETIC SYSTEM FOR GEOPHYSICAL PROSPECTING

(71) Applicant: BRGM, Orléans Cedex 2 (FR)

(72) Inventor: Pierre-Alexandre RENINGER, Olivet (FR)

(73) Assignee: BRGM, Orléans Cedex 2 (FR)

(21) Appl. No.: 18/294,813

(22) PCT Filed: Jun. 30, 2022
(86) PCT No.: PCT/EP2022/068200

§ 371 Date: Feb. 2, 2024

(30) Foreign Application Priority Data
Aug. 4, 2021 (FR) 2108473

(51) Int. Cl. G01V 3/10; G01V 3/17

(52) U.S. Cl. CPC G01V 3/105; G01V 3/17

(57) ABSTRACT

The present disclosure relates to an electromagnetic system for geophysical prospecting, including a transmitting antenna and a receiving antenna, said transmitting antenna comprising at least one set of transmitting electromagnetic loops, said receiving antenna being formed by at least one receiving electromagnetic loop, wherein the transmitting electromagnetic loops of a same set are positioned in different planes parallel to one another.

The present disclosure relates to an electromagnetic system for geophysical prospecting, in particular an airborne electromagnetic system for geophysical prospecting or that is usable on the ground.

Controlled source electromagnetism (EM) is a method making it possible to image the electrical conductivity/resistivity contrasts of the subsoil, a particularly relevant parameter for obtaining a detailed description thereof.

The EM method has proven to be of interest in varied environmental issues, such as geological knowledge (aid in geological mapping and 3D modeling of the subsoil), hydrogeology (management and vulnerability of the water resource), prospecting for materials or mining (exploration and evaluating deposits), natural hazards (aid in mapping random ground movement and seismic hazard), pollution (vulnerability of the subsoil and monitoring of pollution) and geotechnical (information about the nature of the subsoil for construction and regional development). The EM method therefore constitutes an efficient imaging method, exploited in numerous fields.

This technique can operate in the frequency or temporal domain, on the ground or airborne (airplane or helicopter). It includes injecting into a transmitting loop an electric current, varying over time, in order to create a magnetic field, also variable, and in listening to the response from the subsoil following this excitation, at one or several receiving loops.

The strength of the transmitted signal depends on the zone of the loop, the number of turns and the amperage of the injected current. Given that each of these parameters has implications in terms of autonomy and/or aerodynamics and/or implementation and/or resolution, it is necessary to find the best compromise.

Currently, there is a growing need to adapt the EM method to a light aerial vehicle, in order to be able to implement it on so-called intermediate surfaces (catchment zones, fields, quarries, dikes, plateaus, etc.), for the use of manufacturers as well as communities. High resolution data acquisition (both lateral and vertical) on so-called intermediate surfaces, of first importance for a large majority of environmental problems of socio-economic importance, remains difficult to envisage for the so-called heavy ground and “conventional” airborne systems. In addition, for the latter, the use of large devices carried by Ecureuil type helicopters does not allow a flexible and rapid implementation, at reduced cost. Current airborne temporal systems generally have a horizontal transmitting loop of several hundred m² and can weigh more than 500 kg, which is not directly transposable to light aircraft. This is therefore conducive to the emergence of unprecedented geometry, of limited span.

The purpose of the present disclosure is to remedy the disadvantages of the prior art, by proposing an electromagnetic system for geophysical prospecting that can adapt to light aircraft and that adapt to the need for associated lateral and vertical resolutions.

To this end, the present disclosure relates to an electromagnetic system for geophysical prospecting comprising a transmitting antenna and a receiving antenna, said transmitting antenna comprising at least one set of transmitting electromagnetic loops, said receiving antenna being formed by at least one receiving electromagnetic loop, wherein the transmitting electromagnetic loops of a same set are positioned in different planes parallel to one another.

### Benefits

Such an arrangement of the transmitting electromagnetic loops makes it possible to constrain the transmitted magnetic field in terms of geometry and intensity and, in certain configurations, to increase its intensity, without increasing the number of turns, the zone of the transmitting antenna and therefore its size, or even reducing its size, and without increasing the amperage of the injected electric current, thus optimizing the current cut-off time, as will be explained below.

Furthermore, the electromagnetic system for geophysical prospecting according to the present disclosure (hereinafter “prospecting system”) can be adapted to a payload on a light aircraft. For example, the transmitting loops of a same set can be positioned vertically, making it possible to limit the horizontal size while generating either a pseudo-vertical magnetic field, or a horizontal magnetic field as a function of the injected current; a pseudo-vertical magnetic field makes it possible to obtain data close to those measured with a horizontal loop, while reducing the size. The transmitting loops of a same set can also be positioned horizontally, making it possible to increase the intensity of the magnetic field while limiting the size. These configurations of the transmitting loops of the system according to the present disclosure can also be implemented on the ground.

In the context of the present description, “vertical” refers to an orientation locally/substantially perpendicular to the constant altitude planes, and “horizontal” means an orientation locally parallel to the constant altitude planes.

According to one embodiment of the present disclosure, the transmitting electromagnetic loops of a same set are centered on a geometric axis orthogonal to the parallel planes.

According to another embodiment of the present disclosure, the prospecting system includes at least one assembly wherein the transmitting electromagnetic loops are positioned in substantially vertical planes, and/or at least one assembly wherein the transmitting electromagnetic loops are positioned in substantially horizontal planes.

According to another embodiment of the present disclosure, each set of transmitting electromagnetic loops includes pairs of transmitting loops.

According to another embodiment of the present disclosure, the electromagnetic system further includes an electronic transmission card or a set of transmission cards configured to inject an electric current in the same direction into the different transmitting loops of a same set in order to generate a primary magnetic field and to create zones where the primary magnetic field or one of its components is stable and determined.

In particular, the receiving antenna may be arranged at least partly in the zones where the primary magnetic field or one of its components is stable and determined.

According to one embodiment of the present disclosure, the electromagnetic system further includes an electronic transmission card or a set of transmission cards configured to inject an electric current in a certain direction in one or more transmitting electromagnetic loops of a same set, and to inject an electric current in the opposite direction into the other transmitting electromagnetic loop(s) of this same assembly in order to generate a primary magnetic field and to create zones of the space where the intensity of the primary magnetic field or one of its components is weak. The concept of “weak” is defined later.

In particular, the receiving antenna is arranged at least partly in the zones of the space where the intensity of the primary magnetic field or one of its components is weak.

The present disclosure also relates to a method for determining electrical resistivity or conductivity contrasts of a zone of interest of the subsoil using the electromagnetic system as described above, comprising the following steps:
a) arranging the transmitting antenna above the zone of interest of the subsoil,
b) producing a series of measurements where each measurement includes the following sub-steps:
1) generating a primary magnetic field, variable within time and geometric constraints, by activating the transmitting electromagnetic loops so as to excite the subsoil and measure a secondary magnetic field returned by the latter,
2) measuring the secondary magnetic field by the receiving antenna, and
c) determining the contrasts of electrical resistivity or conductivity of the subsoil.

According to one embodiment of the present disclosure, during step 1) the electric current injected into at least one of the transmitting electromagnetic loops of one set is in the opposite direction to the one injected into the other electromagnetic loops of said set.

According to another embodiment of the present disclosure, during step 1) the electric current injected into the transmitting electromagnetic loops of a same set is in the same direction.

In particular, step 1) includes:
a sub-step 1A) wherein the electric current injected into at least one of the transmitting electromagnetic loops of one set is in the direction opposite to the one injected into the other electromagnetic loops of the set, and
a sub-step 1B) wherein the electric current injected into the transmitting electromagnetic loops of a same set is in the same direction.

### BRIEF DESCRIPTION OF THE FIGURES

The various disclosed embodiments will be better understood upon reading the following description, which is provided solely by way of example and with reference to the appended drawings, wherein:

FIG. 1 shows an example of an electromagnetic system for geophysical prospecting according to an embodiment.

FIG. 2 shows various embodiments (2A to 2E) of a transmitting antenna of an electromagnetic system for geophysical prospecting according to an embodiment.

FIG. 3 shows different modes of generating a primary magnetic field (3A and 3C: currents in the same direction; 3B and 3D: currents in the opposite direction) by a pair of transmitting loops of an electromagnetic system according to an embodiment.

FIG. 4 shows the generation of a secondary magnetic field from a subsoil using the electromagnetic system for geophysical prospecting of FIG. 1.

### DETAILED DESCRIPTION

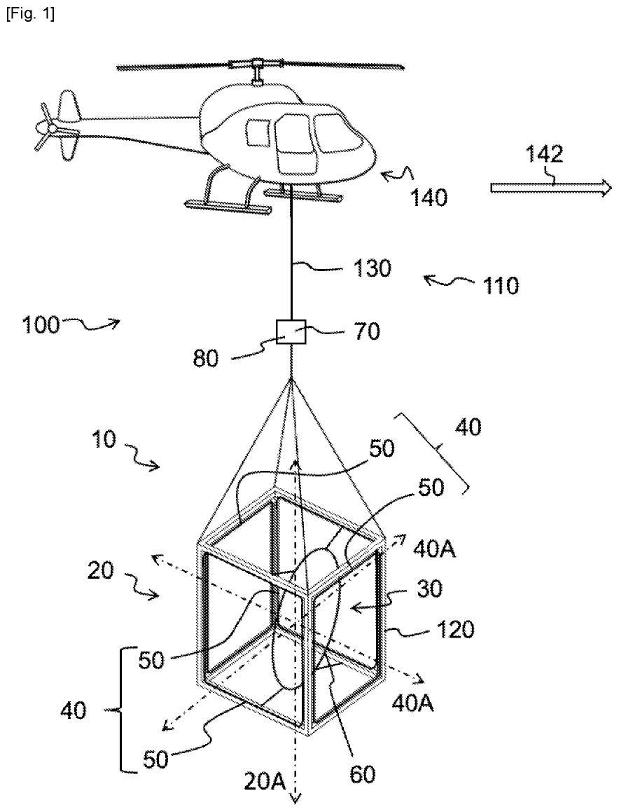

FIG. 1 shows an example of an electromagnetic system 10 for geophysical prospecting according to an embodiment. The electromagnetic prospecting system 10 includes a transmitting antenna 20 and a receiving antenna 30.

The transmitting antenna 20 includes at least one set 40 of transmitting electromagnetic loops, the transmitting electromagnetic loops 50 (hereinafter “transmitting loops”) of a same set 40 being positioned in different planes parallel to one another.

According to a preferred embodiment, the transmitting electromagnetic loops 50 of a same set 40 are centered on a geometric axis 40A orthogonal to the parallel planes. Thus, two transmitting electromagnetic loops 50 of a same set 40 are opposite one another.

Subsequently, the axis of rotation 20A of the transmitting antenna 20 is called the central geometric axis around which the transmitting loops 50 are positioned. Said axis of rotation 20A is present when all the transmitting loops 50 are in planes having a parallel direction, in particular vertical or horizontal.

It is said that the transmitting antenna 20 is vertical when all the transmitting loops 50 of the sets 40 are arranged in the vertical planes. In this embodiment, the transmitting antenna 20 includes a vertical axis of rotation 20A around which the transmitting loops 50 are positioned.

It is said that the transmitting antenna 20 is horizontal when all the transmitting loops 50 of the sets 40 are arranged in horizontal planes. In this embodiment, the transmitting antenna 20 includes a horizontal axis of rotation 20A around which the transmitting loops 50 are positioned.

The receiving antenna 30 is formed by at least one electromagnetic receiving loop 60 (hereinafter receiving loops), which can also be arranged horizontally or vertically.

The transmitting loops 50 and receiving loops 60 can take any form. They may in particular be of circular, oval, square, rectangular, solenoidal or even polygonal shape.

The transmitting loops 50 are “active” loops. They each generate a magnetic field varying over time in order to excite the subsoil 200. These magnetic fields are generated using an electric current varying over time (hereinafter simply “electric current”) and passing into electrical cables forming the transmitting loops 50. For each transmitting loop 50, the electrical cable can make one or several turns. A larger number of turns increases the effective zone of a transmitting loop 50 and therefore the intensity of the generated magnetic field. Each transmitting loop 50 includes an independent electrical cable, so that it is possible to modify the characteristics of the electric current (direction, intensity, frequency, etc.) flowing through each transmitting loop 50 independently of one another, as will be described below.

The magnetic field corresponding to the sum of all these magnetic fields is called “primary magnetic field”.

Due to its variability over time, the primary magnetic field excites the subsoil 200, resulting in the induction of eddy currents. These eddy currents in turn generate a magnetic field (called “secondary”). This secondary magnetic field is measured at the receiving loops 60. The receiving loops 60 are said to be “passive”. They do not generate a magnetic field. They include, just like the transmitting loops 50, an electrical cable, which can have several turns, into which no electric current is injected. It is the interaction between the receiving loops 60 and the secondary magnetic field that induces an electric current which is then analyzed. In the present disclosure, the receiving loop(s) 60, allowing an indirect measurement of the secondary magnetic field, can be replaced by one or more devices such as magnetometers, allowing direct measurement of the magnetic field. Everything related hereinafter to the position of the receiving loop or loops also applies to the device or devices allowing direct measurement of the magnetic field.

The secondary magnetic field, and therefore the electric current induced in the receiving loops 60, provides information about the conductivity/resistivity of the subsoil 200. Its measurement and the analysis of the induced electric current therefore make it possible to establish a resistivity/conductivity model of the analyzed zone of the subsoil 200, and to deduce the elements present in the subsoil 200, their locations and their geometries. This model (representation of the subsoil 200 such as a map) can be in one, two, three or four dimensions.

### Description of a Set 40 of Transmitting Loops

Within the same set, the transmitting loops 50 are traversed by a geometric axis 40A, orthogonal to the planes containing the transmitting loops 50, and are preferably centered on this geometric axis 40A.

Within a same set 40, the positioning geometry of the transmitting loops 50 can be defined relative to this geometric axis 40A, and in particular relative to the distances 40D separating the various transmitting loops 50 along this geometric axis 40A; this distance can vary between two transmitting loops 50 of a same set 40.

According to one embodiment of the present disclosure, the distance 40D between the various transmitting electromagnetic loops 50 of a same set 40 can range from 0.01 m to 20 m. The least significant separation distances allow optimization of the span of the transmitting antenna for use on the ground or on light aircraft.

According to one embodiment of the present disclosure, the transmitting electromagnetic loops 50 have the same dimensions. In particular, the transmitting loops 50 have a span (longest dimension) ranging from 0.01 to 20 m. The least significant spans allow use on the ground or on a light aerial vehicle. The transmitting loops 50 of a same set 40 can have the same dimensions or different dimensions. Preferably, they have the same dimensions.

Furthermore, the electromagnetic system 10 is configured so that the position of each transmitting loop 50 relative to the vertical and horizontal (relative to the constant altitude planes) is controlled during the use of the electromagnetic system 10, by a self-supporting system 130 (on the ground or airborne).

Thus, the geometric axis 40A orthogonal to the planes containing the transmitting loops 50 can have any inclination between a vertical position (relative to the constant altitude planes) and a horizontal position (relative to the constant altitude planes). When the geometric axis 40A is horizontal, then the transmitting loops 50 are vertical. Conversely, when the geometric axis 40A is vertical, then the transmitting loops 50 are horizontal.

Finally, the geometric axis 40A orthogonal to the planes containing the transmitting loops 50 can constitute a geometric axis around which the transmitting loops 50 can rotate, each in its respective plane.

In brief, the electromagnetic system 10 is configured so that the transmitting loops 50 can have any orientation in space, the single constraint being that the transmitting loops 50 of a same set 40 are positioned opposite in different planes parallel to one another.

According to an advantageous embodiment, the transmitting electromagnetic loops 50 of a same set 40 are positioned in substantially vertical planes (from 70° to) 110°, or in substantially horizontal planes (from −20° to) 20° relative to a constant altitude plane during the use of the electromagnetic system 10. The transmitting electromagnetic loops 50 positioned in substantially vertical planes make it possible to generate a pseudo-vertical or horizontal magnetic field, if necessary, as will be described in detail below. A pseudo-vertical magnetic field makes it possible to obtain data close to those measured with a horizontal loop. The transmitting electromagnetic loops 50 positioned in substantially horizontal planes make it possible to increase the intensity of the magnetic field while limiting the size and the cut-off time.

The transmitting antenna of the prospecting system 10 according to the disclosed embodiments advantageously has one or more sets 40 of transmitting electromagnetic loops 50.

According to one alternative embodiment, the prospecting system 10 includes at least one set 40 wherein the transmitting electromagnetic loops 50 are positioned in substantially vertical planes, and/or at least one set 40 wherein the transmitting electromagnetic loops 50 are positioned in substantially horizontal planes.

Each set of transmitting electromagnetic loops 50 may include pairs of transmitting loops: pair, quadruplet, etc.

In general, the different sets of loops make it possible:
(1) to constrain the geometry and the intensity of the primary magnetic field and thus to constrain the characteristics of the measurement based on the objective; and
(2) to create, in an active manner, zones in space, determinable by methods known to the person skilled in the art, where at least one of the components of the primary field emitted is
weak, that is to say with a value equal to or less than the corresponding component of the secondary magnetic field returned by the subsoil 200, advantageously with a value equal to or less than 10% of the corresponding component of the secondary magnetic field returned by the subsoil 200, and/or
stable.

The receiving loop(s) can preferably be placed in these zones. These aspects will be developed below.

Advantageously, compared to the use of a single transmitting loop, in particular arranged horizontally or vertically, the zones created near the center of the electromagnetic system (that is, within a few meters of the surroundings), and which are therefore easily accessible to arrange the receiving loop(s) therein, have much greater and usable volumes because the intensity of the primary field is stable and/or weak.

Of course, when all the sets of transmitting loops of the antenna are not activated at the same time, as described below, the zones created successively can be situated at different locations and the person skilled in the art will know how to place the receiving loop(s) as judiciously as possible while taking this fact into account.

### Managing the Current in the Transmitting Loops

The electromagnetic system 10 according to disclosed embodiments may further include an electronic transmission card 70 (hereinafter “transmission card”) or a set of transmission cards configured to activate the transmitting loops 50 by the injection of an electric current into each of them. The characteristics of such current can differ between each set 40 but also between each loop 50 of a same set 40. The injection of the current is in particular carried out in a synchronized manner between the different loops 50 of a same set 40 and between the different sets 40 of loops in order to ensure a coherent primary magnetic field is obtained.

The transmission card 70 or the set of transmission cards can be configured to inject an electric current in a certain direction in one or more transmitting electromagnetic loops 50 of a same set 40, and to inject an electric current in the opposite direction into the other transmitting electromagnetic loop(s) 50 of this same set 40. Such a configuration makes it possible, for example, to obtain the generation of a pseudo-vertical primary magnetic field 25 when the geometric axis 40A of the set 40 is arranged horizontally. This embodiment further makes it possible to actively create well defined zones where the intensity of the primary magnetic field, or one of its components, is weak (as defined above), thus limiting the effect of this primary magnetic field on the data measured by receiving loops 60 which would be arranged in these said zones, as will be described in detail below.

Alternatively or additionally, the electronic transmission card 70 or the set of transmission cards can be configured to inject an electric current in the same direction in the different transmitting loops 50 of a same set 40. Also, the transmission card 70 can be configured to alternately inject two induction cycles: the first induction cycle includes injecting an electric current in a certain direction into some electromagnetic transmitting loops 50 of a set 40, and an electric current in the opposite direction into the other transmitting electromagnetic loops 50 of this same set 40; and the second cycle includes injecting an electric current in the same direction into all the transmitting loops 50 of a same set 40.

As will be described below, (1) in the case of a set 40 arranged vertically (all the loops 50 of the set 40 are vertical), this can make it possible to alternate between a vertical configuration and a pseudo-horizontal configuration in order to investigate the subsoil 200 differently and thus to better characterize it, and (2) in the case of a set 40 arranged horizontally (all the loops 50 of the set 40 are horizontal), it is possible to alternate between a measurement dedicated to the imaging of very near surface, by placing for example at least one receiving loop 60 in a zone where the primary magnetic field, or one of its components, is actively weak, and a measurement investigating greater depths. In a case where no zone where a primary magnetic field, or one of its components, actively weak would be easily accessible, it remains possible to obtain a measurement dedicated to the imaging of the very near surface, by placing for example at least one receiving loop 60 around the center of the geometry of the transmitting antenna 20. Indeed, the primary magnetic field is relatively stable and its components can be determined around the center of the geometry. Thus, this makes it possible to predict the effect of the primary field on the measurement, and therefore to correct it or to compensate it.

In addition, the transmission card 70 or the set of transmission cards can be configured to inject various waveforms (that is, intensity as a function of time) (w₀, w₁, w₂, etc.) in each set 40 of loops or in each transmitting loop 50. It is also possible to inject, alternately, different waveforms in order for example to investigate various ranges of depths, as will be described in detail below.

Thus, the transmission card 70 or the set of transmission cards can be configured to generate different frequencies of electric current. This aspect of the present disclosure is particularly useful in the case of frequency-domain prospecting.

Also, the transmission card 70 or the set of transmission cards can be configured to cut off the electric current in the transmitting loops 50 during a time t_{c}. This aspect of the present disclosure is particularly useful for prospecting in the temporal domain. In addition, the transmission card 70 or the set of transmission cards can be configured to cut off the electric current in some of the transmitting loops 50, leaving the others active.

According to one embodiment of the present disclosure, the electromagnetic receiving loop(s) 60 are placed at advantageous positions where the associated component of the primary magnetic field that is created is weak and/or stable and determined. These positions, created actively by the electromagnetic system 10, depend on the geometry and the number of sets 40 used, as well as the characteristics and the direction of the current flowing through the transmitting loops 50. This embodiment has the advantage of allowing the reduction in the effect of the primary magnetic field generated by the transmitting loop(s) 50 at the receiving loop(s) 60. The reception signal obtained, that is, the electric current induced in the receiving loop(s) 60, thus requires less subsequent processing (e.g., compensation, deconvolution) to be used.

The benefit of actively creating zones where the primary field, or one of its components, is weak and/or stable and determined is to better know/limit the width and to optimize it; the placement of the electromagnetic receiving loop(s) 60 is thus facilitated and the reduction in the primary field effect can be optimal. For example, in the case of a pair of loops 50 of a same dimension, placed vertically or horizontally and wherein the currents flowing in them are in opposite directions, it is possible advantageously to place at least one horizontal electromagnetic receiving loop 60 in the horizontal plane passing through the center of the geometry of the set 40. Indeed, the vertical component of the primary magnetic field thereof is theoretically zero. It should also be noted that in the abovementioned sets, the primary magnetic field is theoretically zero at the center of the geometry between the two transmitting loops 50.

In a complementary manner, said or at least one receiving loop 60 may be associated with a compensation coil. Such a compensation coil makes it possible to reduce the effect of the primary field on the signal measured at the receiving loops 60.

According to one embodiment of the present disclosure, the receiving antenna 30 includes several receiving electromagnetic loops 60, placed at different locations where the associated component of the primary magnetic field is weak and/or stable and determined. This makes it possible to improve the signal-to-noise ratio of the overall measurement of a same component of the secondary magnetic field. Several receiving electromagnetic loops 60 can also allow a measurement of the local gradient in order to better characterize the local contrasts. This gradient can be horizontal as well as vertical depending on the position of the receiving loops 60.

The receiving loops 60 can be arranged in any direction.

According to one embodiment of the present disclosure, said or at least one electromagnetic receiving loop 60 is arranged parallel or perpendicular to the axis of rotation 20A of the transmitting antenna 20 or parallel or perpendicular to at least one axis 40A. When several receiving loops 60 are present, they can, independently of one another, be arranged parallel or perpendicular to the axis of rotation 20A of the transmitting antenna 20 or parallel or perpendicular to at least one axis 40A. In particular, the receiving antenna 30 includes at least one receiving loop 60 arranged parallel to the axis of rotation 20A of the transmitting antenna 20 or to at least one axis 40A and at least one receiving loop 60 arranged perpendicular to the axis of rotation 20A of the transmitting antenna 20 or to at least one axis 40A. Indeed, depending on the sets 40 used, a horizontal or vertical, or even pseudo-vertical, primary magnetic field can be created, and this possibly alternately. This is for example the case when a pair of transmitting loops 50 is placed vertically. By adjusting the direction of the current. It is then possible to generate a horizontal and pseudo-vertical primary magnetic field. Thus, the receiving loops 60 measure the response of the subsoil following its excitation by the two types of generated primary magnetic fields. Furthermore, such an arrangement makes it possible to obtain different data which, once compiled, make it possible to better characterize the resistivity/conductivity contrasts of the subsoil 200. This aspect will be described in more detail below, in relation to the prospecting method according to the present disclosure.

The electromagnetic system 10 according to the disclosed embodiments may include a receiving card 80 or a set 80 of receiving cards configured to process the data measured by the receiving antenna 30, in particular by sampling, and to determine the electrical resistivity/conductivity contrasts of the subsoil 200, and in particular, constructing a model in one, two, three or four dimensions of resistivity/conductivity contrasts.

Alternatively, the electromagnetic system 10 according to the disclosed embodiments may also include a communication module in order to send the data measured by the receiving antenna 30 to a processing module external to the electromagnetic system 10 which will process the information and determine the electrical resistivity/conductivity contrasts of the subsoil 200. In this case, the processing module can be arranged at the self-supporting system 130 as described below, or on ground level. In both cases, the electromagnetic system 10 may also include a module for storing the data measured by the receiving antenna 30. The receiving card 80 or the set of receiving cards and, if present, the external processing module 92 are synchronized with the transmission card 70 or the set of transmission cards.

The electromagnetic system 10 according to disclosed embodiments may also include sensors in order to measure the position in space of the antennas for transmission 20 and reception 30, and in particular the inclination, relative to the vertical or the horizontal, the height from the ground and the position relative to the ground. Complementarily, the electromagnetic system 10 may include compensation or readjustment elements configured to compensate or readjust the position of the antenna 20/30 when the sensors 96 detect a deviation. Also, the electromagnetic system 10 can be equipped with elements enabling it to move and follow a 3D trajectory autonomously, such as for example in the “dronization” frame of the system 10, that is to say a transformation of the system 10 to drone, or else the attachment of the system 10 to a drone.

### Assembly of an Electromagnetic System 10 and a Support System 110

The present disclosure also relates to an assembly of an electromagnetic system 10 according to the disclosed embodiments and of a support system 110.

The support system 110 includes a load-bearing structure 120, a vehicle 140, in particular aerial, and a traction system 130 (cables, cords, etc.) connecting the load-bearing structure 120 to the vehicle 140.

According to one embodiment of the present disclosure, the support system 110 or the electromagnetic system 10 further includes a transmission card 70 as defined above.

In particular, the support system 110 or the electromagnetic system 10 may further include the receiving card 80 as defined above.

According to one embodiment of the present disclosure, the vehicle 140 of the support system 110 may be an airplane, a glider, a balloon, an ultra-light aircraft, a helicopter or even one or more drones. In particular, the vehicle 140 preferably belongs to the light aircraft sector. In the case of prospecting on the ground, this vehicle 140 can for example be a quad or an individual.

### Prospecting Method

The present disclosure further relates to a method for using an electromagnetic system 10 as described above for imaging the electrical resistivity/conductivity contrasts of the subsoil 200.

The method for determining the electrical resistivity/conductivity contrasts of the subsoil 200, includes the following steps:
a) the transmitting antenna 20 is arranged above the zone of interest of the subsoil 200,
b) a series of measurements is made where each measurement includes the following sub-steps:
1) generating a primary magnetic field, variable within the restricted time and geometry, by activating the transmitting electromagnetic loops 50 so as to excite the subsoil 200 and measure the secondary magnetic field returned by the latter,
2) measuring the secondary magnetic field at said or at least one electromagnetic receiving loop 60, generally placed vertically or horizontally, preferably at a location where at least one of the associated components of the primary magnetic field is weak and/or stable and determined and
c) determining electrical resistivity/conductivity contrasts of the subsoil 200.

The various steps are described in detail below.

### Step a)

In general, the first step includes arranging the transmitting antenna 20 above the zone of interest of the subsoil 200. The arrangement of several loops 50 vertically and/or horizontally makes it possible to limit the size of the transmitting antenna 20, and therefore offers the possibility of its use on a light aerial vehicle 130.

A vertical arrangement has the advantage of being able to alternate a vertical configuration (horizontal primary magnetic field), unprecedented in the temporal domain, and a pseudo-horizontal configuration (pseudo-vertical primary magnetic field), also unprecedented in the temporal domain, without increasing the size of the transmitting antenna 20, and even by limiting it, thanks to the vertical position of the transmitting loops 50. The pseudo-horizontal configuration, by virtue of the injection of a current in the opposite direction, also makes it possible to limit the effect of the primary magnetic field generated upon reception and therefore to guarantee a good near-surface resolution.

The vertical configuration could make it possible to obtain measurements that can be used for the analysis of cliffs or steep slopes; these objects are very complicated to study with a conventional horizontal configuration. In addition, cliffs or mountainous zones (permafrost, etc.) are areas of increasing interest because they are part of a growing challenge with climate change.

Alternating the vertical and pseudo-horizontal configurations makes it possible to obtain a major break in the type of data collected up until then. This alternation makes it possible to improve the rendering in complex and often challenging environments, where both horizontal and vertical contrasts are expected, such as volcanic, orogenic environments, fault zones or the presence of lenticular geometries in sedimentary basins.

A horizontal arrangement has the advantage of being able to alternate, in a novel manner, between a configuration making it possible to limit the effect of the primary field on reception by injecting a current of opposite direction, and thus to guarantee a good near-surface resolution and a configuration generating a relatively large primary magnetic field, by injecting the current in the same direction. Moreover, this is done while limiting, by virtue of the use of several quite distinct transmitting loops 50 spaced vertically by more than 0.01 m, the span of the geophysical prospecting system 10 as well as the cut-off time of the injected current (in temporal domain). In the case of an identical current direction, a relatively stable and determined primary magnetic field in a zone around the center of the geometry is obtained. The span of this zone depends on the spacing and the number and dimensions of the transmitting loops 50.

During this step, the receiving loop(s) 60 are arranged in a vertical and/or horizontal plane.

### Step b)

This step corresponds to obtaining data making it possible to determine the electrical resistivity/conductivity contrasts of the subsoil 200.

### Step 1)

This step corresponds to the generation of a primary magnetic field by activating the transmitting electromagnetic loops 50. In particular, this step is carried out by injecting an electric current in a synchronized manner into each of the transmitting loops 50, in particular by virtue of an electrical transmission electronic card 70 as defined above. In particular, the electric current in each transmitting loop 50 has, for example, the same intensity.

It is then possible to constrain the geometry and the intensity of the primary magnetic field generated by adjusting the configuration of the transmitting antenna 20 and the parameters of the current injected into each of the transmitting loops 50.

According to one embodiment of the present disclosure, during step 1) the electric current injected into at least one of the transmitting electromagnetic loops 50 of a set 40 is in the opposite direction to the one injected into the other electromagnetic loops 50 of said set 40. This makes it possible, among other things:
(1) to create, in an active manner, zones in space, determinable by methods known to the person skilled in the art, where at least one of the components of the primary field emitted is weak, both for the horizontal as well as the vertical configurations. This makes it possible to limit the effect of said primary magnetic field on the reception and thus to guarantee a good near-surface resolution;
(2) to generate a pseudo-vertical primary magnetic field (with a pseudo-horizontal configuration of the system) by arranging the transmitting loops 50 vertically. Note that in this configuration, the component of the secondary magnetic field that is of interest first of all is the vertical component, which will be measured by means of at least one receiving loop 60 arranged horizontally, that is to say perpendicular to the transmitting loops 50. This makes it possible to benefit from zones where the vertical component of the primary field is weak on the plane passing through the center of said transmitting loops 50.

Alternatively or additionally, during step 1) the electric current injected into the transmitting electromagnetic loops 50 is in the same direction. In the case of transmitting loops 50 arranged vertically, it is then possible to generate a horizontal magnetic field (vertical configuration), useful for characterizing limited 2D/3D bodies in space, vertical contrasts and high-relief environments (cliffs, mountainous zones) where the use of a conventional horizontal configuration reaches its limits. In the case of transmitting loops 50 arranged horizontally, this makes it possible to increase the intensity of the generated primary magnetic field while limiting the size and the cut-off time of the injected current. In addition, this makes it possible to create a relatively stable and determined primary magnetic field at the center of the geometry.

A combination of these two embodiments (injection of the current in the opposite direction and in the same direction) is advantageous in that it makes it possible to benefit from the advantages of these two modes and thus to improve the capacities of the electromagnetic system 10 in terms of (horizontal and vertical) resolution, depth of investigation and/or characterization of complex objects, while limiting the size of said device.

Thus, in particular, step 1) can include:
a sub-step 1A) wherein the electric current injected into at least one of the transmitting electromagnetic loops 50 of a set 40 is in the opposite direction to that injected into the other electromagnetic loops 50 of the set 40, and
a sub-step 1B) wherein the electric current injected into the transmitting electromagnetic loops 50 is in the same direction.

According to one embodiment of the present disclosure, step 1) can include:
a sub-step i) wherein the electric current injected into each activated transmitting electromagnetic loop 50 has an intensity I₀, and
a sub-step ii) wherein the electric current injected into each activated transmitting electromagnetic loop 50 has an intensity I₁, where I₁ is greater than I₀.

The intensity of the current injected into each transmitting loop 50 can be the same for all the loops 50 or else be different for each transmitting loop 50 or for each set 40 of transmitting loops 50.

In the temporal domain, alternating intensity of the injected current in the transmitting loops 50 generally makes it possible to obtain information at different depths. Thus, a strong intensity will provide information about greater depths than weaker intensity, but will be accompanied by a decrease in the near-surface resolution due to an increased cut-off time.

According to a particular embodiment of the present disclosure, the sub-steps 1A) and 1B) can each include the sub-steps i) and ii) or vice versa.

According to one embodiment of the present disclosure, where the electromagnetic system 10 includes several sets 40 of transmitting electromagnetic loops 50, step b) is carried out by successive time activation of certain sets 40 of transmitting electromagnetic loops 50, so that when certain transmitting electromagnetic loops 50 are activated the others are not.

In particular, the sets 40 of transmitting electromagnetic loops 50 are distributed in several transmission groups, each transmission group corresponding to one or more sets 40 of transmitting electromagnetic loops, each transmission group being successively activated over time during step b) so that when one transmission group is activated the other or the others are not.

In particular, the activation of a transmission group may include the sub-steps 1A) and/or 1B) and/or the sub-steps i) and/or ii).

According to a particular embodiment of the present disclosure, in the temporal domain, the activation duration of a transmitting electromagnetic loop 50, that is, the duration during which an electric current is injected before being cut off, generally ranges from 0.1 to 20 milliseconds.

### Step 2)

This step includes measuring a secondary magnetic field following the excitation of the subsoil using the generated primary magnetic field and its variation over time. The temporal variation of this field will induce eddy currents in the subsoil. These eddy currents in turn create a so-called secondary magnetic field. The characteristics of the secondary magnetic field depend, in the first order, on the resistivity/conductivity of the rocks and/or of the fluids passing through. Thus, the measurement of the secondary magnetic field provides information on the resistivity/conductivity of the investigated volume, the latter being increasingly large, laterally and vertically, with time or decrease in frequency.

The measurement of the secondary magnetic field can be carried out according to two different domains, a frequency domain or a temporal domain.

In the frequency domain, the electric current passing through the transmitting loops 50 is injected at specific frequencies and the secondary magnetic field (in-phase and quadrature component) is measured simultaneously at the receiving loops 60. In this domain, the frequency, the nature of the noise and the conductivity of the subsoil 200 control the depth of investigation. Thus, the lower the frequency, the deeper the layers that will be investigated.

In particular, during step 2), several frequencies can be transmitted by the same set 40 according to a sequence or simultaneously by the different sets. The secondary magnetic field for each frequency is then measured at said or at least one electromagnetic receiving loop 60.

In temporal domain, the signal is transmitted during a time t₁, then cut off during a time to, and the subsoil response is sampled over a defined time interval tₘ. The investigated depth depends on the time elapsed between the start of the cut-off and the measurement, the noise level and the conductivity of the subsoil 200. Thus, the measurement of the secondary magnetic field at a time close to the cut-off (called short time) provides information about the near-subsoil and vice versa. Furthermore, the fact of cutting the primary magnetic field (during or before the measurement) makes it possible to limit its effect on reception. The faster the cut-off, the more it is possible to measure, in short times, a secondary magnetic field undisturbed by the primary field and therefore to image the near-subsoil, without particular processing/methodologies being necessary. The temporal domain will be preferred in what follows. A parallel with the frequency domain can be carried out using methods known to the person skilled in the art.

According to one embodiment of the present disclosure, during step 2) the measurement of the secondary magnetic field at said or at least one electromagnetic receiving loop 60 is synchronized with the transmitting electromagnetic loops 50. The time interval tₘ may include tᵢ and t_{c}, or only t_{c} or begin after t_{c}.

As specified above, the measurement during t_{c} or very quickly after to makes it possible to characterize the very near-subsoil. However, it is affected by the primary magnetic field. After t_{c}, even though the current is cut, a residual primary magnetic field can persist for a few moments in the receiving loop(s) 60. Also, for the characterization of the near surface, it is possible to favor the injection of a current in the opposite direction into the transmitting loops 50 and the placement of at least one receiving loop 60 in a zone where the associated component of the primary magnetic field is weak.

Conversely, the more the time passes, the more the measurement of the secondary magnetic field is indicative of significant depths. One parameter limiting the investigation depth is the ambient noise level. The signal-to-noise ratio can be improved by increasing the intensity of the electric current injected into the transmitting loops 50 and therefore the intensity of the primary magnetic field. Interestingly, in the horizontal or vertical configuration of the system, a current of a same direction in the various transmitting loops 50 makes it possible to increase the intensity of the primary magnetic field and to obtain a better signal/noise ratio, without there being a need to increase the value of the intensity of the injected electric current, the number of turns or the zone of the transmitting loops 50. This preserves the cut-off time, and moreover, this aspect of the disclosed embodiments may be important for an operation by light aircraft vehicle 130, where it is difficult to have high amperage and/or large zone loops. It may also be envisaged to use more loops 50 per set 40 and/or set 40 in order to increase the intensity of the primary magnetic field without adversely affecting the size and the cut-off time and without the need to increase the current amperage.

### Step c)

Step c) relates to the processing of the measured data in order to determine the electrical resistivity/conductivity contrasts present in the subsoil 200 and to construct a model, in one, two, three or four dimensions.

Firstly, it is necessary to reject the noise present in the data in order to avoid any artifact on the model obtained. For this, so-called “stack” and filter methods, in particular low-pass filters, are applied during the measurement and in post-processing. Procedures that make it possible to reduce the effect of the primary field over the short times can then be used. Finally, the remaining noise is generally rejected with thresholding or equivalent type techniques, or by using conventional statistical processing.

Once noise has been removed from the measurements, inversion procedures known to the person skilled in the art are applied in order to image the resistivity/conductivity contrasts from the originally acquired signals. These procedures can be deterministic or stochastic and consider a subsoil in one, two, three or four dimensions.

According to one embodiment of the present disclosure, the electromagnetic system 10 is moved, in particular at a constant speed, in particular according to a flight plan, during the implementation of steps a) to c).

According to one embodiment of the present disclosure, in the case of a vertical configuration (the transmitting loops 50 are vertical), at least one set 40 of transmitting electromagnetic loops 50 is arranged in the direction of the movement of the electromagnetic system 10 and at least one set 40 of transmitting electromagnetic loops 50 is arranged along the perpendicular to the direction of the movement of the electromagnetic system 10. “In the direction of movement” is understood to mean that the loops 50 of a set 40 are opposite one another in the direction of movement. This aspect of the present disclosure is interesting in that it makes it possible to obtain data both in the direction of movement and in its perpendicular, which is not possible with configurations where the transmitting loops are horizontal. This can make it possible to improve the characterization of the subsoil 200 in that it allows its investigation in a different way, since the investigated volumes and their orientations differ. For example, the response and the characterization of a vertical contrast will depend on the difference in orientation between this contrast and the transmission.

### Exemplary Embodiments

FIG. 1 shows an assembly 100 according to an embodiment comprising an electromagnetic system 10 and a support system 110. In the embodiment shown, the support system 110 includes a small helicopter 140 connected, by means of the traction system 130 (cables/ropes), to a load-bearing structure 120 on which the electromagnetic system 10 is attached.

The electromagnetic system 10 shown includes a transmitting antenna 20 formed here of two pairs 40 of vertical transmitting loops 50. The transmitting loops 50 here have a rectangular shape, but they could assume any shape. The loops 50 of a pair 40 are arranged opposite one another, parallel to one another, and associated with an axis of rotation 20A and at least one geometric axis 40A.

The helicopter 140 has a flight direction 142 above the ground 300. In the embodiment shown in FIG. 1, one of the pairs 40 of transmitting loops 50 is arranged in the flight direction 142, and the other loop 50 is arranged along the perpendicular to this flight direction 142. This arrangement makes it possible to collect data according to the direction of the flight and its perpendicular, in particular by alternating the injection or by simultaneously injecting the current into the pairs 40 of loops.

The electromagnetic system 10 also has a receiving antenna 30 comprising one or several receiving loops 60. These receiving loops 60 are here arranged either vertically or horizontally to advantageous positions as will be described below. In the embodiment shown in FIG. 1, a single receiving loop 60 is present and arranged at the center of the electromagnetic system 10. The receiving loops 60 shown have a circular shape, but they could have any other shape. The use of several receiving loops 60 for the measurement of a same component of the secondary magnetic field allows greater averaging of the data or the calculation of the gradient as a function of their positions and their spacings.

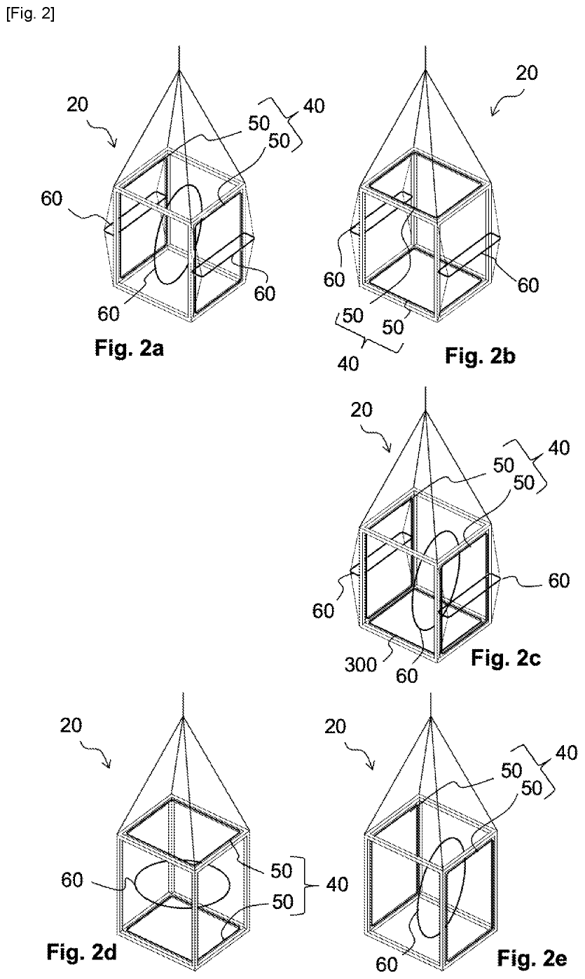

FIGS. 2A to 2E show other embodiments of the electromagnetic system 10 according to the disclosed embodiments.

In FIG. 2A, a transmitting antenna 20 can be seen comprising a pair 40 of transmitting loops 50 and three receiving loops 60. Two loops of the three receptions 60 are arranged horizontally on either side of the pair 40 of transmitting loops and the last receiving loop 60 is arranged vertically between two transmitting loops 50 at the center of the electromagnetic system 10.

In FIG. 2B, the transmitting antenna 20 includes a pair 40 of horizontal transmitting loops 50 and two receiving loops 60 also arranged horizontally. In this embodiment, the receiving loops 60 are not arranged opposite the transmitting loops 50.

In the embodiment shown in FIG. 2C, the transmitting antenna 20 includes a pair 40 of vertical transmitting loops 50, a horizontal transmitting loop 50 and three receiving loops 60 arranged as in FIG. 2A.

In FIG. 2D, the transmitting antenna 20 includes a pair 40 of horizontal transmitting loops 50 and a horizontal receiving loop 60 arranged at the center of the electromagnetic system 10.

In FIG. 2E, the transmitting antenna 20 includes a pair 40 of vertical transmitting loops 50 and a vertical receiving loop 60 arranged at the center of the electromagnetic system 10.

Returning to FIG. 1, it can be seen that the transmitting loops 50 and the receiving loops 60 are held in position by virtue of the load-bearing structure 120. This load-bearing structure 120 may also carry a housing enclosing a transmission card 70 and a receiving card 80; said housing can also be arranged directly at the traction system 130 (cables/ropes). Said transmission card 70 is configured to inject an electric current into each of the transmitting loops 50. The receiving card 80 is configured to process the data received by the receiving loop 60.

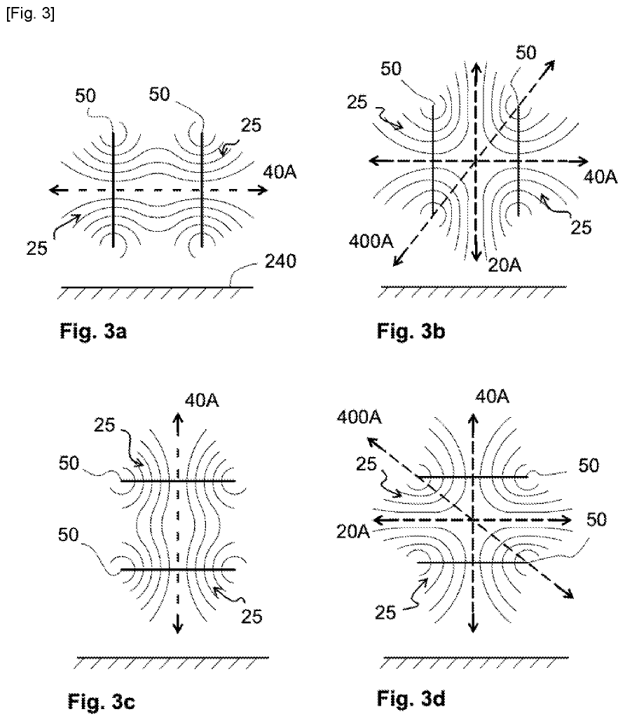

Reference is now made to FIGS. 3A to 3D which show the magnetic field (25; 25′) emitted by a pair 40 of transmitting loops 50 of an electromagnetic system 10 associated with a geometric axis 40A, according to different current injections in these loops 50; said pair 40 of loops 50 is arranged either vertically (FIGS. 3A and 3B) or horizontally (FIGS. 3C and 3D) relative to the ground 240. In FIGS. 3A and 3C, an electric current in the same direction is injected into the two loops 50 of the pair 40. Thus, the magnetic field 25 emitted by each of the loops 50 has the same shape and turns in the same direction. This makes it possible to increase the intensity of the emitted magnetic field, oriented perpendicular to the transmitting loops 50. In FIGS. 3B and 3D, the electric current injected into each of the loops 50 is in the opposite direction. Thus, the primary magnetic field (25) generated by each of these loops 50 turns in the opposite direction. It will be noted here that the fields turning in the opposite direction repel one another. For the vertical configuration (FIG. 3B), it follows that the general shape of the magnetic field generated by these loops 50 approaches a vertical magnetic field generated by a horizontal loop. This configuration of the system 10, called pseudo-horizontal, therefore makes it possible to obtain data close to a conventional horizontal configuration. By virtue of this injection mode, it is possible to actively generate zones where the primary magnetic field 25, or at least one of its components, is weak. In this case, a zone where the vertical component of the primary magnetic field 25 is weak is located at the horizontal plane passing through the center of the electromagnetic system 10. It is at these zones that the receiving loops 60 are advantageously arranged so that the measurements are biased only weakly by the primary magnetic field emitted by the transmitting loops 50. It should be noted that there are also zones characterized by a component of the weak primary magnetic field when currents are injected in the same direction, although these are much more limited in space.

The arrangement of the receiving loops 60 can also be adapted as a function of the component of the secondary magnetic field 230 that is to be measured. FIGS. 3B and 3D show the geometric axes 20A and 40A as well as a third geometric axis 400A perpendicular to the axes 20A and 40A. In a case where it is desired to measure the component of the secondary magnetic field 230 perpendicular to the axis of rotation of the transmitting antenna 20A, the arrangement of the receiving loops 60 in the plane formed by the axes 40A and 400A will be preferred. In a case where it is desired to measure the component of the secondary magnetic field 230 perpendicular to the geometric axis 40A, the arrangement of the receiving loops 60 in the plane formed by the axes 20A and 400A will be preferred. Finally, in a case where it is desired to measure the component of the secondary magnetic field 230 perpendicular to the axis 400A, the arrangement of the receiving loops 60 in the plane formed by the axes 40A and 20A will be preferred.

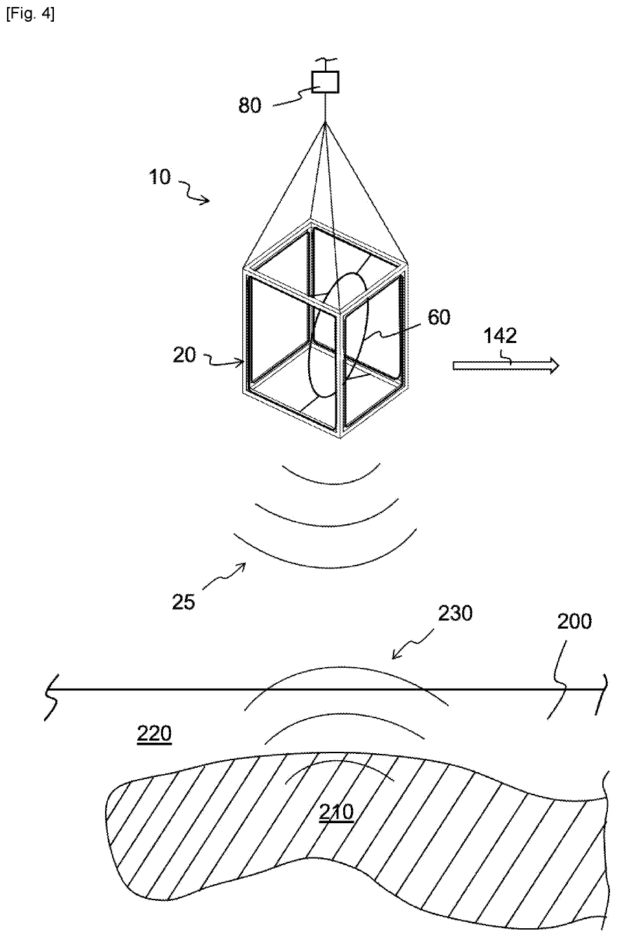

Finally, reference will be made to FIG. 4, which shows the kinematics of determining the conductivity/resistivity contrasts of the subsoil 200 by the electromagnetic system 10 according to the disclosed embodiments as shown in FIG. 1. In this subsoil 200 there is a particular layer 210 characterized by an electrical resistivity/conductivity different from that of its surrounding 220; this may be due to a change in lithology, a different level of alteration, a different fluid saturation, etc. The purpose of the electromagnetic system 10 is to detect the contrast between this particular layer 210 and the surrounding 220, its position and its geometry in the subsoil 200. For this, the transmitting antenna 20 emits a primary magnetic field 25, variable over time and represented here by a signal. This temporal variation of the magnetic field 25 excites the subsoil 200 and the layer 210, which in turn emit a secondary magnetic field 230, shown here also by a signal. The secondary magnetic field is measured at the receiving loop 60. The analysis of the secondary magnetic field 230 is carried out in a synchronized manner with the injection of current(s) characterized by a waveform. Here, the subsoil 200 is studied by a succession of transmission (generation of a primary magnetic field 25) and reception (measurement of the secondary magnetic field at the receiving loop 60) during the movement of the electromagnetic system 10 in the flight direction 142 and the flight plan. Each measurement is analyzed by the receiving card 80 in order to restore a model of the resistivity/conductivity contrasts of the subsoil 200.

The present disclosure is not limited to the embodiments presented, and other embodiments will become clearly apparent to the person skilled in the art.

The present disclosure has been described according to one example where the secondary magnetic field was determined by measuring the electric current induced in the receiving loops 60. However, it would not be outside the scope of the present disclosure if the system 10 included, alternatively or in addition to the receiving loops 60, a device for direct measurement of the magnetic field.

What is claimed is:

1. An electromagnetic system for geophysical prospecting comprising a transmitting antenna and a receiving antenna, said transmitting antenna comprising at least one set of transmitting electromagnetic loops, characterized in that the transmitting electromagnetic loops of a same set are positioned in different planes parallel to one another.

2. The electromagnetic system according to claim 1, wherein the transmitting electromagnetic loops of a same set are centered on a geometric axis orthogonal to parallel planes.

3. The electromagnetic system according to claim 1, wherein the electromagnetic system comprises the at least one set of transmitting electromagnetic loops wherein the transmitting electromagnetic loops are positioned in at least one of: substantially vertical planes and substantially horizontal planes.

4. The electromagnetic system according to claim 1, wherein each set of the at least one set of transmitting electromagnetic loops comprises at least a pair of the transmitting loops.

5. The electromagnetic system according to claim 1, further comprising an electronic transmission card or a set of electronic transmission cards configured to inject an electric current in a same direction into the different transmitting loops of a same set in order to generate a primary magnetic field and to create zones of space where the intensity of the primary magnetic field or one of its components is stable.

6. The electromagnetic system according to claim 5, wherein the receiving antenna is arranged at least partly in the zones of the space where the intensity of the primary magnetic field or one of its components is stable and determined.

7. The electromagnetic system according to claim 1, further comprising an electronic transmission card or a set of electronic transmission cards configured to inject an electric current in a certain direction into one or more transmitting electromagnetic loops of a same set, and to inject an electric current in an opposite direction into the other transmitting electromagnetic loop(s) of this same set in order to generate a primary magnetic field and to create zones where the primary magnetic field or one of its components is weak.

8. The electromagnetic system according to claim 7, wherein the receiving antenna is arranged at least partly in the zones where the primary magnetic field or one of its components is weak.

9. A method for determining electrical resistivity or conductivity contrasts of a zone of interest of a subsoil, comprising:
a) arranging a transmitting antenna above the zone of interest of the subsoil, wherein the transmitting antenna comprises at least one set of transmitting electromagnetic loops, characterized in that the transmitting electromagnetic loops of a same set are positioned in different planes parallel to one another;
b) producing a series of measurements where each measurement comprises the following sub-steps:
1) generating a primary magnetic field, variable within time and geometric constraints, by activating the transmitting electromagnetic loops so as to excite the subsoil and measure a secondary magnetic field returned by the subsoil,
2) measuring the secondary magnetic field by a receiving antenna; and
c) determining the electrical resistivity or conductivity contrasts of the subsoil, wherein an electromagnetic system includes the transmitting antenna and the receiving antenna.

10. The method according to claim 9, wherein during step 1) an electric current injected into at least one of the transmitting electromagnetic loops of a set is in an opposite direction to the electric current injected into the other electromagnetic loop of said set.

11. The method according to claim 9, wherein during step 1) the electric current injected into the transmitting electromagnetic loops of a same set is in a same direction.

12. The method according to claim 10, wherein step 1) further comprises:
a sub-step 1A) injecting an electric current into at least one of the transmitting electromagnetic loops of a set in an opposite direction to the electric current injected into the other electromagnetic loop of the set, and
a sub-step 1B) injecting the electric current into the transmitting electromagnetic loops of a same set is in a same direction.

13. The method according to claim 9, wherein the primary magnetic field is generated by injecting an electric current by any one of: an electronic transmission card and a set of electronic transmission cards.
